(19) United States
(12) Patent Application Publication
(10) Pub. No.: US 2012/0132048 A1
(43) Pub. Date: May 31, 2012

(54) ELECTRIC SAW DEVICE HAVING TWO SAW BLADES

(75) Inventor: JOHN CHUNG -KUANG CHEN, Vara (SE)

(73) Assignee: NEWSTAR (ASIA) LTD, TSUEN WAN (CN)

(21) Appl. No.: 13/052,459

(22) Filed: Mar. 21, 2011

(30) Foreign Application Priority Data
Nov. 29, 2010 (CN) 201010563454.1

(51) Int. Cl. B23D 45/10; B23D 61/18

(52) U.S. Cl. 83/495

(57) ABSTRACT

An electric saw device having two saw blades being arranged for allowing the two saw blades to be driven to rotate in opposite directions. The two saw blades are respectively formed with circular grooves on their inner surfaces at positions corresponding to each other while enabling the centers of the two circular grooves to aligned with the rotation axes of corresponding saw blades. The electric saw device has a plurality of steel balls, each being sandwiched between the two saw blades while insetting into the circular grooves simultaneously, by that the saw blades are separated from each other by a specific interval. Accordingly, when the two saw blades are rotating in opposite direction, each of the steel balls is acting as a roller bearing for maintaining the two saw blades to be properly separated from each other, and thus preventing the two saw blades from overheating and softened by friction.

### FIELD OF THE INVENTION

The present invention relates to an electric saw device having two saw blades, and more particularly, to an electric saw device having two saw blades being arranged for allowing a plurality of steel balls to be disposed therebetween while enabling each steel ball to be used as a roller bearing for separating the two saw blades by a specific gap, and thereby, preventing the two saw blades from overheating by friction, enhancing the cutting precision and prolonging the service life of the saw blades.

### BACKGROUND OF THE INVENTION

In a conventional electric saw device having two saw blades, a first saw blade and a second saw blade are driven to rotate simultaneously in opposite directions to saw a work piece. Please refer to FIG. 1A, which is a schematic diagram showing a double-blade structure with two saw blades according to the prior art. As shown in FIG. 1A, blade heads 52 and 53 of the first and the second saw blades 40 and 41 are arranged in contact with each other. Consequently, while being used in a cutting process, the blade heads 52 and 53 may generate a high temperature due to the contact friction. Moreover, the blade heads 52 and 53 of the two saw blades 50 and 51 may easily collide with each other, causing the blade heads 52 and 53 to fall off or even be broken, and thus shortening the service life of the two saw blades 50 and 51.

In the cutting process using the two saw blades 50 and 51 shown in FIG. 1A, the first and the second saw blades 40 and 41 may be slightly softened due to the heat generated by friction. Accordingly, the first and the second saw blades 50 and 51 may expand slightly due to the resistance in the cutting, causing a distance between the blade heads 52 and 53 of the first and the second saw blades 40 and 41 to increase slightly, which may be wide enough for a cut piece 54 resulting from the cutting process to be clamped between the first and the second saw blades 50 and 51, as shown in FIG. 1B. Meanwhile, the cutting line width resulting from the use of the saw blades 50 and 51 will also increase, which may adversely influence the cutting precision of the cutting process. With the increasing of the distance between the blade heads 52 and 53 of the first and the second saw blades 50 and 51, the problem of having cut pieces 54 being clamped between the saw blades 50 and 51 is becoming more and more serious, and eventually the gap between the first saw blade 50 and the second saw blade 51 will be filled by cutting pieces 54, causing a motor for driving the two saw blades 50 and 51 to rotate to burn out by overload.

Please refer to FIG. 2A, which shows a double-blade structure having a pair of saw blades disclosed in WO 08/057,028. The double-blade structure shown in FIG. 2A is configured primarily for solving the problem of having cut pieces 54 being clamped between the saw blades 50 and 51, as shown in FIG. 1B, and the problem of having the blade heads 42 and 43 being damaged by colliding with each other. As shown in FIG. 2A, in the double-blade structure with the pair of saw blades 60 and 61, a circular rib 65 is disposed on the second saw blade 61, which urges against an inner surface 64 of the first saw blade 50 to be used for maintaining an interval to be formed between the two saw blades 60 and 61. Substantially, the rib 55 is formed for keeping a safe distance (0.03 mm) between blade heads 62 and 63 of the two saw blades 60 and 61 so as to allow the double-blade structure to operate normally. Moreover, by the arrangement of the rib 65, the cutting pieces can be prevented from being clamped between the two saw blades 60 and 61.

However, when the two saw blade 50 and 51 are used for performing a cutting process, there will be heat being generated from the friction between the rib 65 and the first saw blade 60, by that the first saw blade 50 may be softened, causing adverse affect upon the cutting precision. Furthermore, it is noted that after a period of usage, there will be wear and tear either to the rib 65, as shown in FIG. 2B, or to the first saw blade 60, as shown in FIG. 2C, and when the total abrasion to the rib 65 and the first saw blade 60 is equal to or greater than the distance (0.03 mm) between the blade heads 62 and 63 of the two saw blades 60 and 61, the blade heads 62 and 63 may collide with each other, such that the electric saw device can no longer operate normally, and thus, the saw blades 60 and 61 must be replaced.

Please refer to FIG. 3A and FIG. 3B, which are schematic diagrams showing a structure capable of preventing the two saw blades in a saw device from colliding with each other by having steel balls sandwiched between the two saw blades according to the prior art. As shown in FIG. 3A, there is a plurality of steel balls 72 being equiangularly disposed and sandwiched between the first saw blade 70 and the second saw blade 71. Consequently, by the disposition of the plural steel balls 72, the two saw blades 70 and 71 can be properly separated from each other, and thus preventing the two saw blades 70, 71 from overheating by friction and thus softened. Nevertheless, there can also be wear and tear to the steel balls 72 after being used for a period of time, causing the blade heads 73 and 74 to collide with each other. In the condition when the blade heads 73 and 74 are colliding with each other that is resulting from the wear and tear of the steel balls 72, such steel balls 72 will have to be replaced. Therefore, it is in need of a structure capable of alleviating the wear and tear of the steel balls 72 in view of prolonging the service life of the steel balls 72, so as to enhance the usage convenience of the electric saw device.

### SUMMARY OF THE INVENTION

The primary object of the present invention is to provide an electric saw device having two saw blades, being arranged for allowing a plurality of steel balls to be disposed therebetween for separating the two saw blades by a specific gap, and thereby, preventing the two saw blades from overheating by friction and thus softened.

The secondary object of the invention is to provide an electric saw device having two saw blades, capable of enabling the friction resistance to each and every steel balls disposed between the two saw blades to be reduced with the increasing amount of the steel balls that are being disposed, and thus alleviating the wear and tear of the steel balls while prolonging the service life of the same.

To achieve the above objects, the present invention provides an electric saw device having two saw blades, i.e. a first saw blade and a second saw blade, being arranged for allowing the two saw blades to be driven to rotate in opposite directions, in which the two saw blades are respectively formed with circular grooves on their inner surfaces at positions corresponding to each other while enabling the centers of the two circular grooves to aligned with the rotation axes of their corresponding saw blades, and the electric saw device further has a plurality of steel balls, each being sandwiched between the two saw blades while insetting into the circular grooves simultaneously for separating the two saw blades by a specific interval.

In an embodiment of the invention, the amount of the steel balls to be arranged between the two saw blades are not plentiful enough for filling the whole circular grooves, while allowing each and every arc section in each circular groove that has no steel ball inset therein to be smaller than 120 degrees, and thereby, enabling the arrangement of the plural steel balls to construct a three-point support mechanism at any time while being rotatabley inset inside the circular grooves.

In an embodiment of the invention, the portion of each steel ball that is inset into one of the two circular grooves is smaller than half of the steel ball in volume for ensuring the steel ball to rotate smoothly.

In an embodiment of the invention, each of the plural steel balls is magnetized for enabling the same to be attached to the saw blades, and thus facilitating the assembling of the steel balls.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is a schematic diagram showing a double-blade structure with two saw blades according to the prior art.

FIG. 1B is a schematic diagram showing how a cutting piece can be clamped between two saw blades in the double-blade structure shown in FIG. 1A.

FIG. 2A shows a double-blade structure having a pair of saw blades disclosed in WO 08/057,028.

FIG. 2B is a schematic diagram showing a state in which the rib of FIG. 2A is worn.

FIG. 2C is a schematic diagram showing a state in which one of the saw blades of FIG. 2A is worn.

FIG. 3A is a schematic diagram showing a double-blade structure configured with steel balls sandwiched between the two saw blades according to the prior art.

FIG. 3B is a rear view of the double-blade structure shown in FIG. 3A.

FIG. 4 is a cross sectional view of an electric saw device according to an embodiment of the invention.

FIG. 5 is an exploded view of a double-blade structure composed of a first saw blade and a second saw blade according to the present invention.

FIG. 6 is a front view of the second saw blade of FIG. 5.

FIG. 7 is a rear view of the first saw blade of FIG. 5.

FIG. 8 is a partial enlarged view of the double-blade structure shown in FIG. 5.

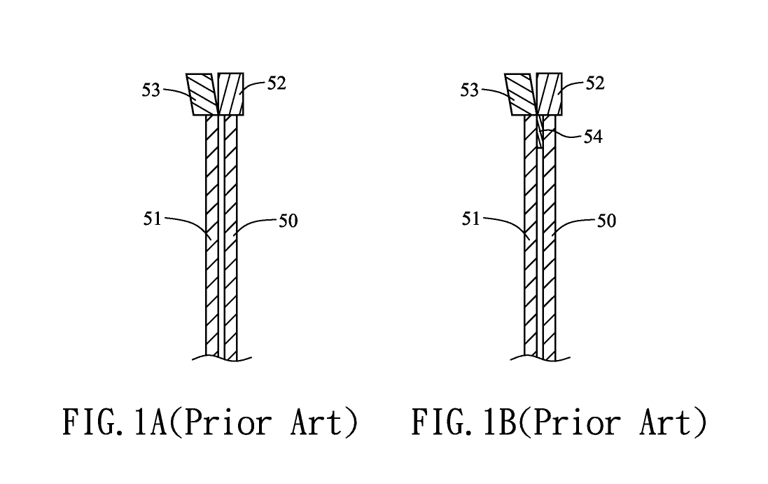

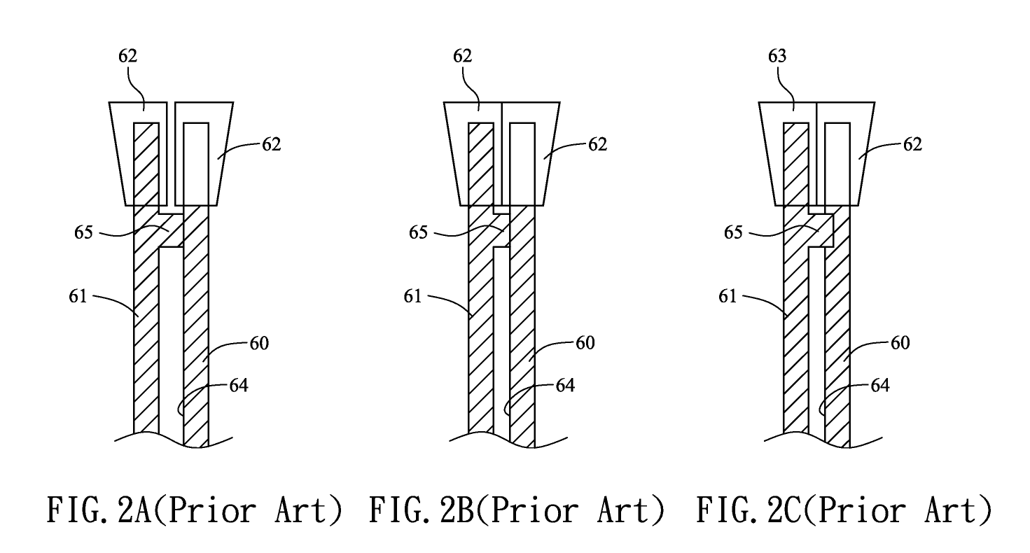

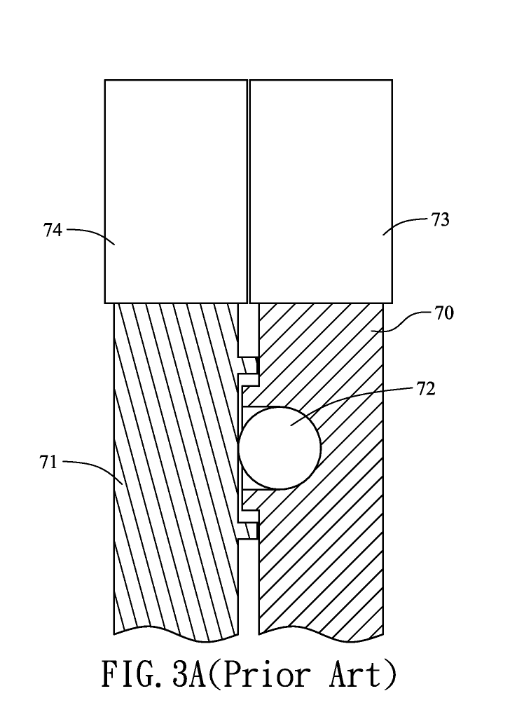

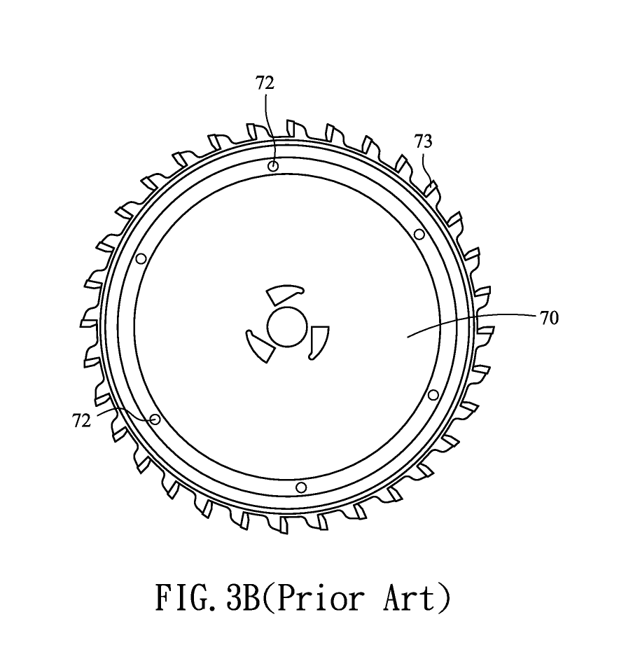

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

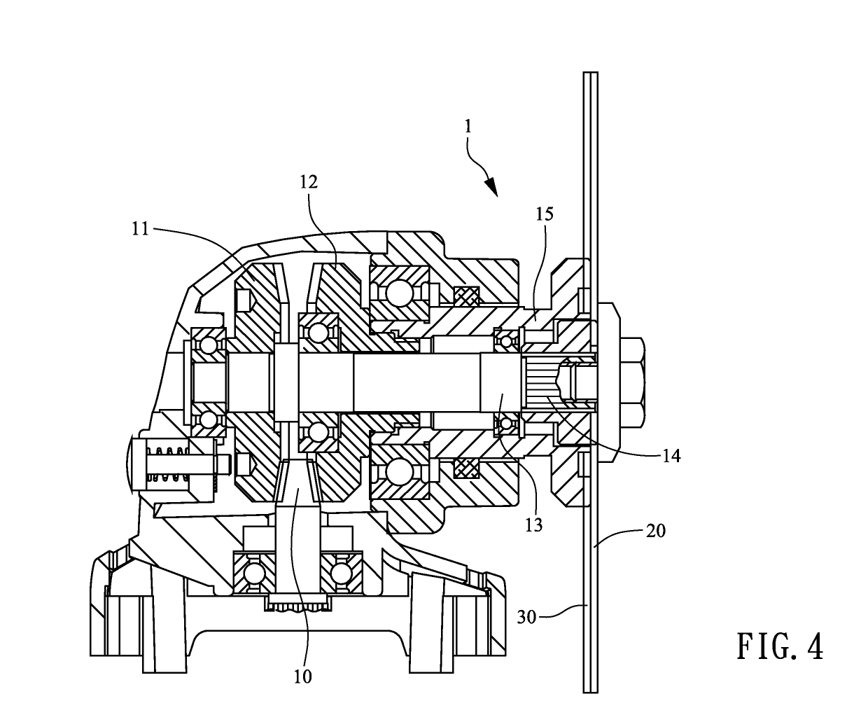

Please refer to FIG. 4, which is a cross sectional view of an electric saw device according to an embodiment of the invention. As shown in FIG. 4, in the electric saw device 1, two gears 11 and 12 are driven by a motor power shaft 10 to rotate at a same speed in opposite directions. The gear 11 is fixed to a power output shaft 13, the power output shaft 13 is fixed to a small transmission shaft 14, and the transmission shaft 14 is coupled to a first saw blade 20 for driving the same to rotate. The other gear 12 is fixed to a large transmission shaft 15, and the large transmission shaft 15 is coupled to a second saw blade 30 for driving the same to rotate. Thereby, when the electric saw device 1 operates, the first and the second saw blades 20 and 30 are being driven rotate in opposite directions.

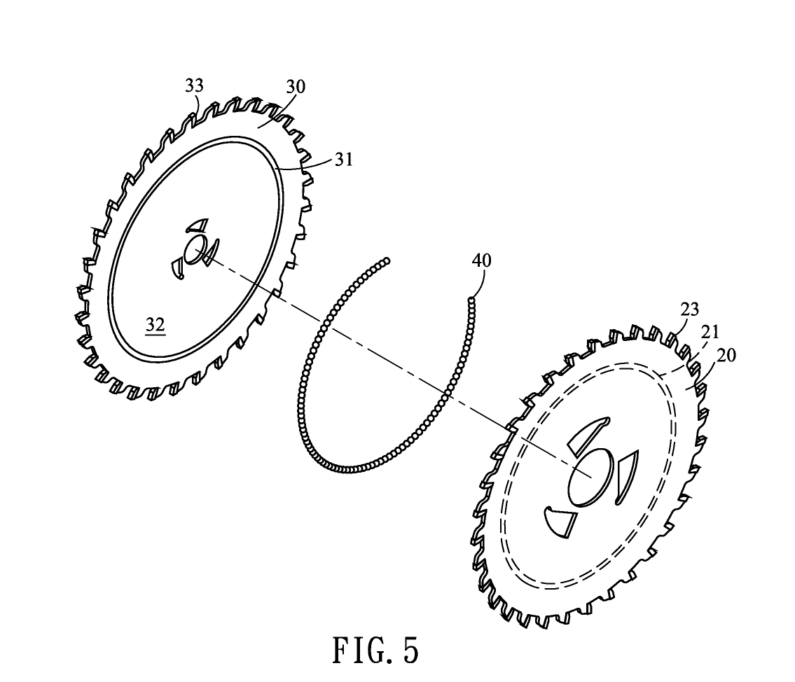

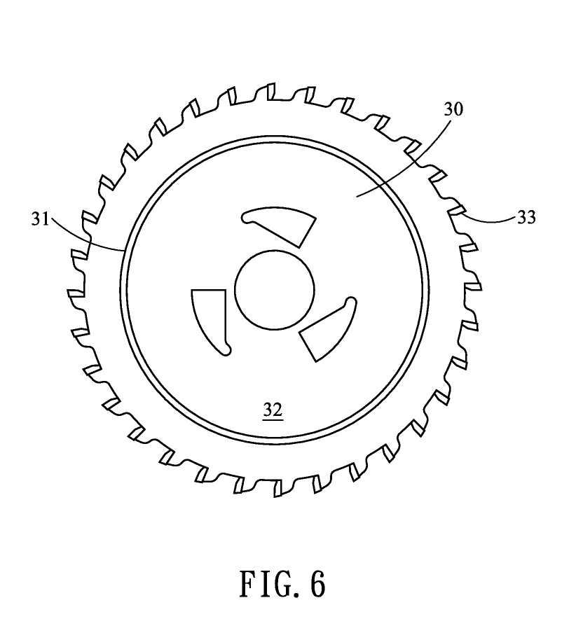

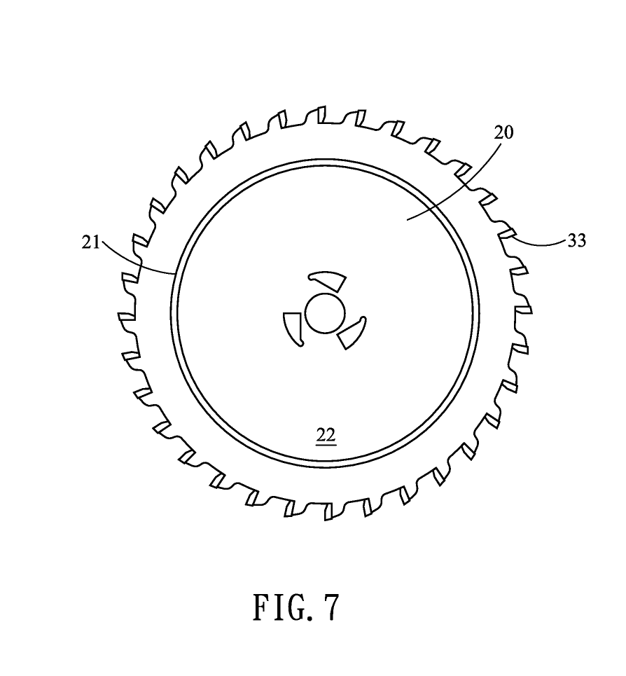

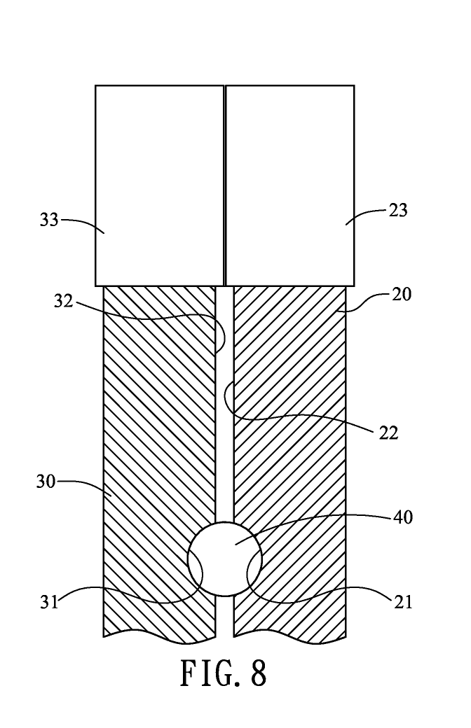

Please refer to FIG. 5, which is an exploded view of a double-blade structure composed of a first saw blade and a second saw blade according to the present invention. As shown in FIG. 5, the first saw blade 20 is formed with a circular groove 21 at its inner surface, i.e. the rear end of the first saw blade 20, while the second saw blade 30 is also formed with a circular groove 31 at its inner surface, i.e. the front end of the second saw blade 30, by that the two circular grooves 21 and 31 are arranged at positions corresponding to each other. As shown in FIG. 6 and FIG. 7, the circular groove 21 of the first saw blade 20 is formed with a diameter equal to that of the circular groove 31 of the second saw blade 30, and also the centers of the two circular grooves 21 and 31 are arranged at positions aligned with the rotation axes of their corresponding saw blades 20 and 30. Moreover, the electric saw device 1 further has a plurality of steel balls 40 in a manner that each of the plural steel balls 40 is sandwiched between the two saw blades 20 and 30 while insetting into the circular grooves 21 and 31 simultaneously for separating the two saw blades 20 and 30 by a specific interval. Please refer to FIG. 8, which is a partial enlarged view of the double-blade structure shown in FIG. 5. As shown in FIG. 8, the contact between the two saw blades 20 and 30 is in a rolling contact due to the rolling of the steel balls 40, so that the friction resulting from such rolling contact is comparatively smaller, and thus the rising of temperature resulting from such friction will not be too great. Consequently, the cutting precision is improved and the life of the saw blades 20 and 30 is prolonged as the two saw blades 20 and 30 will not be softened by overheating. Meanwhile, as the wear and tear of those steel balls 40 can be recognized in their early stage by a consumer if the noise of the operating electric saw device 1 is becoming too loud, the consumer can simply replace the worn steel balls 40 before the steel balls 40 had been worn away too severely for causing the two rotation saw blades 20 and 30 to collide with each other and thus being damaged thereby. Thus, the early detection of worn steel balls can help preventing the cost for replacing the entire double-blade structure of the first and second saw blades 20 and 30, so that the maintenance cost can be reduced.

The design principle of the invention is that the amount of the steel balls 40 to be arranged between the two saw blades 20 and 30 should not be plentiful enough for filling the whole circular grooves 21 and 31, while allowing each and every arc section in each circular groove that has no steel ball 40 inset therein to be smaller than 120 degrees, and thereby, enabling the arrangement of the plural steel balls 40 to construct a three-point support mechanism at any time while being rotatabley inset inside the circular grooves 21 and 31. It is noted that if the circular grooves 21 and 31 are jammed with the steel balls 40, the rolling of each steel ball 40 may easily be obstructed by its neighboring steel balls, causing the two saw blades 20 and 30 to get stuck. In addition, for facilitating the smooth rolling of each steel ball 40 inside the circular grooves 31 and 31, the portion of each steel ball 40 that is inset into the circular grooves 21 should be smaller than half of the steel ball 40 in volume, while the portion of the same steel ball 40 that is simultaneously inset into another circular groove 31 should also be smaller than half of the steel ball 40 in volume. Moreover, by arranging the plural steel balls 40 to be distributed in a comparatively larger area, the friction to each of the plural steel balls 40 can be reduced and therefore the wear and tear to each steel ball is alleviated, so that the service life of each steel ball 40 is prolonged.

As shown in FIG. 8, the blade head 23 of the first saw blade 20 is arranged protruding out of the inner surface 22 of the first saw blade 20 by 0.11 mm, and also the blade head 33 of the second saw blade 30 is arranged protruding out of the inner surface 32 of the saw blade 30 by 0.11 mm, while the blade head 23 of the first saw blade 20 and the blade head 33 of the second saw blade 30 is spaced from each other by 0.03 mm. Consequently, the inner surface 22 of the first saw blade 20 is spaced from the inner surface 32 of the second saw blade 30 by an interval of 0.25 mm, and width measured from the portion of each steel ball 40 that is not inset in the circular grooves 21 and 31 is 0.25 mm.

To ensure that the steel balls 40 do not fall off easily while being inset into the circular grooves 21 and 31 of the first saw blade 20 and the second saw blade 30, the steel balls 23 are magnetized for enabling the same to be attached to the saw blades 20 and 30, and thus facilitating the assembling of the steel balls 40.

To sum up, the present invention provides an electric saw device having two saw blades 20 and 30, being arranged for allowing a plurality of steel balls 40 to be disposed therebetween for achieving a type of rolling support mechanism between the two saw blades 20 and 30, and thereby, preventing the two saw blades 20 and 30 from overheating by friction while enabling the cutting precision of the two saw blades 20 and 30 to be enhanced and also enabling the service life of the two saw blades 20 and 30 to be prolonged. Moreover, the present invention provides an electric saw device having two saw blades, capable of enabling the wear and tear to each and every steel balls disposed between the two saw blades to be reduced with the increasing amount of the steel balls that are being disposed, and thus prolonging the service life of the same as the requirement for replacing the steel balls is minimized.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An electric saw device having a first saw blade and a second saw blade, being arranged for allowing the two saw blades to be driven to rotate in opposite directions; wherein, the two saw blades are respectively formed with circular grooves on their inner surfaces at positions corresponding to each other while enabling the centers of the two circular grooves to aligned with the rotation axes of their corresponding saw blades, and the electric saw device further has a plurality of steel balls, each being sandwiched between the two saw blades while insetting into the circular grooves simultaneously for separating the two saw blades by a specific interval.

2. The electric saw device of claim 1, wherein each of the plural steel balls is magnetized for enabling the same to be attached to the saw blades.

3. The electric saw device of claim 1, wherein the amount of the steel balls to be arranged between the two saw blades are not plentiful enough for filling the whole circular grooves, while allowing each and every arc section in each circular groove that has no steel ball inset therein to be smaller than 120 degrees.

4. The electric saw device of claim 1, wherein the portion of each steel ball that is inset into one of the two circular grooves is smaller than half of the steel ball in volume.

5. The electric saw device of claim 1, wherein each of the plural steel balls is magnetized for enabling the same to be attached to the saw blades.
